(19) United States
(12) Patent Application Publication
(10) Pub. No.: US 2012/0152701 A1
(43) Pub. Date: Jun. 21, 2012

(54) ROLLER SUITABLE FOR USE WITH A MAIL DISTRIBUTION SYSTEM

(76) Inventor: Henning Kern, Wurzburg (DE)

(21) Appl. No.: 13/384,659

(22) PCT Filed: Jul. 21, 2010
(86) PCT No.: PCT/EP2010/060544

§ 371 Date: Feb. 27, 2012

(30) Foreign Application Priority Data
Jul. 30, 2009 (EP) 09009870.8

(51) Int. Cl. B65G 15/60

(52) U.S. Cl. 198/842

(57) ABSTRACT

A roller suitable for use in a mail distribution system comprises a pedestal, an axle body inclineably attached to the pedestal via a fixable spherical plain bearing, at least one roller bearing supported by the axle body, and a roller tube rotatably supported by the at least one roller bearing such that the roller tube is rotatable relative to the pedestal.

The invention relates to a roller, in particular a stationary roller for a mail distribution system, including a pedestal, a roller tube and at least one roller bearing rotatably bearing the roller tube relative to the pedestal.

DE 10 2007 049 442 A1 describes a stationary roller for mail distribution systems that includes a roller outer tube having a cavity; the roller outer tube can be rotatably borne on an axle and/or a pedestal by two coaxially-disposed roller bearings disposed in the cavity. In order to design the roller in an especially assembly-friendly and cost-effective manner, it is proposed therein to fix the relative positions of the roller bearings in a simple manner by using an elastomeric body assembly.

For example, stationary rollers are utilized in a letter distributing machine for guiding conveyer belts. The design of the letter distributing machine generally provides two parallel rows of stationary rollers, between which the conveyer belts, e.g., which convey letters, run along. Thus, among other things, long stretches and large height differences are overcome and also directional changes are performed. Up to now, the factory-installed, pre-assembled, fixed stationary rollers are replaced at the installation location of the letter distributing machine, if necessary, with specialized, adjustable stationary rollers at locations necessary therefor. To check the correct positioning, the letter distributing system must first be operated and must be repeatedly stopped to calibrate it. This is very time- and cost-intensive.

It is an object of the invention to improve a roller, such as e.g., a stationary roller for a mail distributing system, to preferably facilitate a running of the belt over the roller in a trouble-free manner. In particular, disturbances in the running of the belt, which can arise, e.g., due to manufacturing imprecisions or unevenness in the substrate, should be quickly, and thereby cost-effectively, reduced and/or eliminated in a simple way, preferably during initiation of operation.

The object of the invention is achieved by a roller, in particular a stationary roller for a mail distribution system, including a pedestal, a roller tube and at least one roller bearing rotatably bearing the roller tube relative to the pedestal, and further including an axle body, on which the roller tube is rotatably borne by the at least one roller bearing and which is attached to the pedestal by a fixable spherical plain bearing.

By attaching the axle body to the pedestal by using a spherical plain bearing, the angular position of the rotational axis of the roller tube, which is rotatably borne on the axle body, can be adjusted relative to the longitudinal extension of the pedestal. The axle body is set relative to the pedestal at least in so far as the axle body itself can not be displaced due to the operational forces when the operation forces occur. In this respect, the axle body can be retained relative to the pedestal by only a force-fit or friction-fit connection without a rigid, e.g., interference-fit locking device relative to the pedestal being required. The roller tube can be rotatably borne on the axle body by one, two or more roller bearings.

The orientation of the roller tube can be adjusted and/or displaced in a simple manner relative to a belt guided on the roller tube by a fixable spherical plain bearing according to the invention. Such a displacement also can be performed, if necessary, during operation. The roller tube is thereby movable, in particular without having to alter the prior position of the roller and/or the pedestal. By means of special further developments of the invention, a one-hand-displacement of the roller tube, in particular with only one tool, is also possible. The roller can be formed in a self-clamping and/or spring-biased manner.

The spherical plain bearing can be formed as a ball-and-socket joint, whose first spherical plain bearing part, in particular a ball-shaped head, is connected with the axle body and whose second spherical plain bearing part, in particular a ball socket, is connected with the pedestal. The ball-shaped head is not required to be formed larger than a half of a ball, but rather can instead be formed merely by a circular disk-shaped cutout from one convex side of the ball outer surface. The ball socket is not required to be formed to be able to encompass a ball head up to its equator, but rather the ball socket can instead be formed merely by a circular disk-shaped cutout from a concave side of a ball outer surface. A retention of the ball head and ball socket can be ensured by specialized clamping means, in particular by an inventive clamping device.

The axle body can comprise a first spherical plain bearing part of the spherical plain bearing and can formed with a sleeve that has a sleeve bore, in which a clamping device for fixing the first spherical plain bearing part relative to a second spherical plain bearing part of the pedestal is disposed. The clamping device can be formed not only to hold together the two spherical plain bearing parts and/or the ball-shaped head and the ball socket, but can also be formed to fix, i.e. to set or to lock, the pivotability and the rotatability of the spherical plain bearing.

The clamping device can include a screw that has a screw head borne relative to the sleeve and a thread segment screwed into the pedestal. The spherical plain bearing can be fixed, i.e. set or locked, by the screw. The screw can be associated with a spring, in particular a compression spring coil, which retains the two spherical plain bearing parts and/or the ball-shaped head and the ball socket.

The clamping device can include a spring, in particular a compression spring coil, inserted between the screw and the sleeve, which urges the first spherical plain bearing part against the second spherical plain bearing part in a friction-fit manner to fix the spherical plain bearing. Not only the two spherical plain bearing parts and/or the ball-shaped head and the ball socket can be held together by the spring, in particular the compression spring coil, but also the spring can also apply a force onto the connection of the spherical plain bearing parts and/or the ball-shaped head and the ball socket, which presses these two parts against one another in a friction-fit manner, so that the joint is fixed, i.e. set or locked, due to the friction force.

In all inventive embodiments, the screw can have a shaft, which is led through the first spherical plain bearing part of the axle body, in particular through the ball-shaped head of the sleeve, and the thread segment of the screw is screwed into the pedestal in the region of the second spherical plain bearing part, in particular the ball socket.

The screw head can be held in an eccentric component that has an eccentric projection, which is rotatably supported relative to an inner wall of the sleeve. By rotating the screw head, the eccentric component and thus the projection move, in response to the rotational direction, upward or downward and slides along an inner wall of the downwardly-narrowing sleeve. The sleeve is thereby tipped and/or pivoted by a small or large angle relative to the vertical direction and/or the longitudinal direction of the pedestal.

In addition or in the alternative, the screw head can be held in an eccentric component that has an eccentric projection, which is rotatably supported relative to an inner wall of the sleeve, which narrows downwardly in diameter.

In all embodiments, the eccentric component can be rotatably borne between the screw head and a spherical washer that is pressed by a spring, in particular a compression spring coil, against the eccentric component.

The screw can include a screw head having a screw profile, in particular an inner six-edge profile or an inner multi-edge profile, that is accessible from an end side of the roller tube that is opposite of the pedestal. Similarly, the eccentric component can have a screw profile, in particular an inner six-edge profile or an inner multi-edge profile, that is accessible from an end side of the roller tube that is opposite of the pedestal.

In summary, the invention provides in other words a roller, which basically includes a pedestal and a roller tube rotatably and hingedly borne thereon. In this respect, the stationary roller is comprised of two elements, namely the pedestal and a roller body comprising a roller tube, a sleeve having a bearing and an adjustment mechanism. The pedestal can have the shape of a six-edged rod or however can also be cylindrical. The pedestal can have a threaded bore on its underside for mounting onto a machine and can comprise a spherical recess on the upper side.

The roller body can be comprised of a hollowed-out sleeve, on whose outer side the bearing seat is located. The roller tube can be fixed over the bearing by snap rings. The sleeve can have a spherical, i.e. ball-shaped, end on its underside. The spherical and/or ball-shaped end can have the same diameter as the spherical recess in the pedestal. The sleeve and thus the roller can be inclined in any direction due to the ball-shaped bulge. This adjustment mechanism operates according to the principle of a ball-shaped head and a ball socket. A ball-shaped recess can be located in the sleeve. The ball-shaped recess can have a defined angle. The ball-shaped recess acts against the eccentric piece. By screwing in the screw, the eccentric piece, which is supported against the screw head and is centered, is pushed relative to the ball, thereby angularly orienting the roller body in a corresponding manner. The farther the screw is screwed in, the larger the angle is. The screw, which is centrally screwed into the pedestal, makes it possible to apply a force via the eccentric piece to the spherical washer and via the compression spring to the bottom of the sleeve; the force is sufficiently high to fix the roller body in the desired position. The force can be determined by the spring constant.

By rotating the eccentric piece, the position of the angle and/or the deviation of the roller can be finely adjusted. This can take place without having to alter the previously-set angle. This can be achieved by separating the adjusting in axial components of screw and ball, and by the radial components of the eccentric. The eccentric piece can be finely adjusted by an inner six-edge, which is integrated into the upper portion.

An exemplary embodiment of the invention is illustrated in an exemplary manner in the appended schematic drawings.

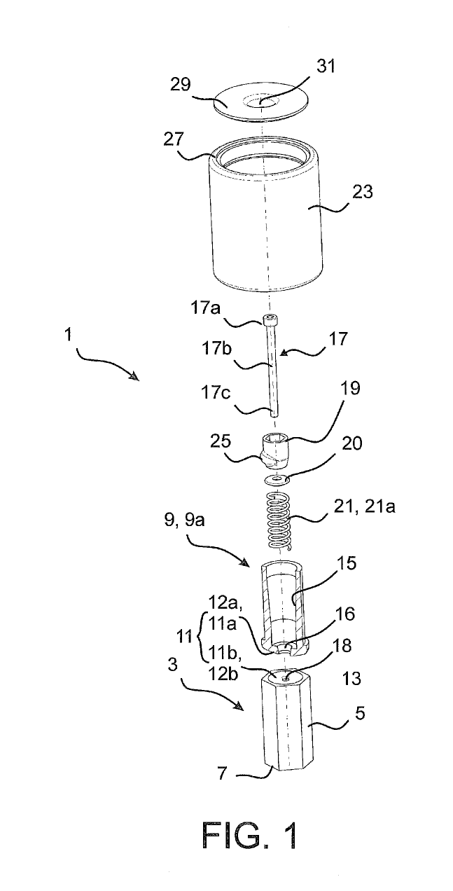

FIG. 1 shows a perspective, exploded illustration of an embodiment of an inventive roller,

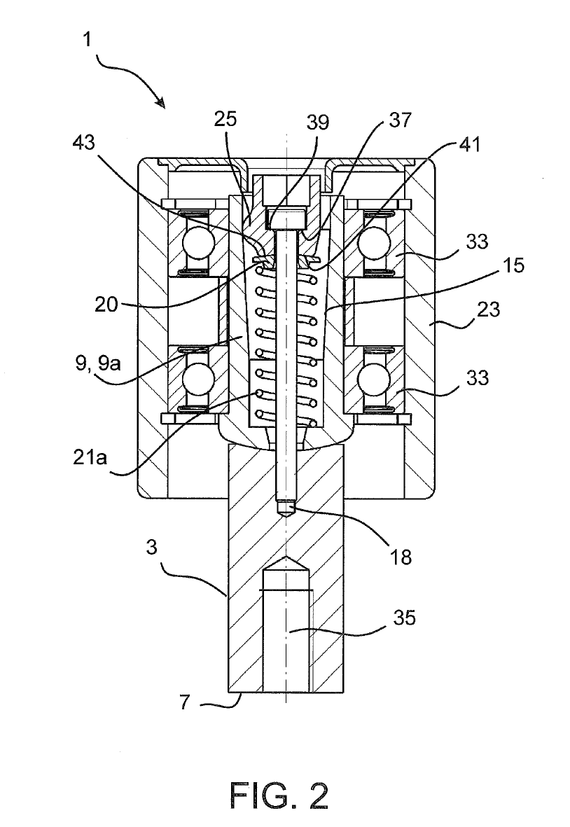

FIG. 2 shows a cross-sectional view of the roller according to FIG. 1,

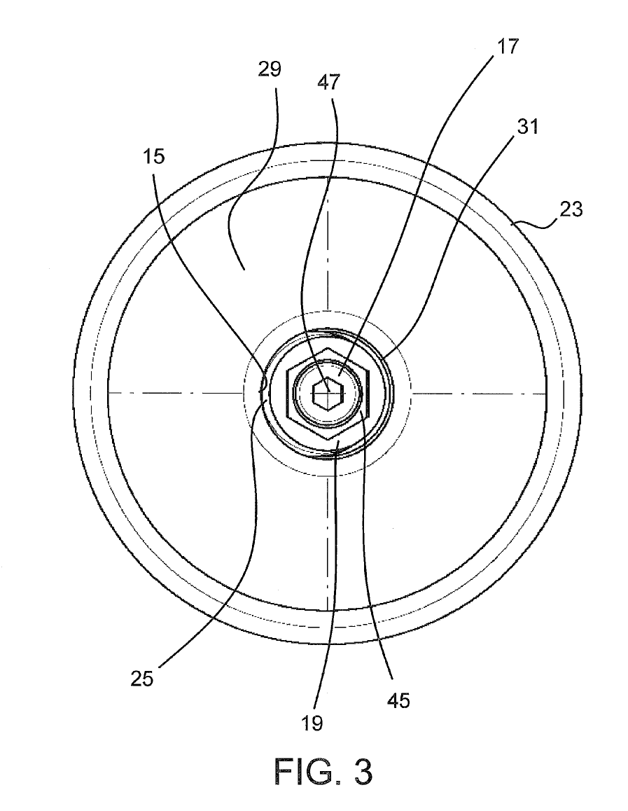

FIG. 3 shows a top view of the roller according to FIGS. 1, and

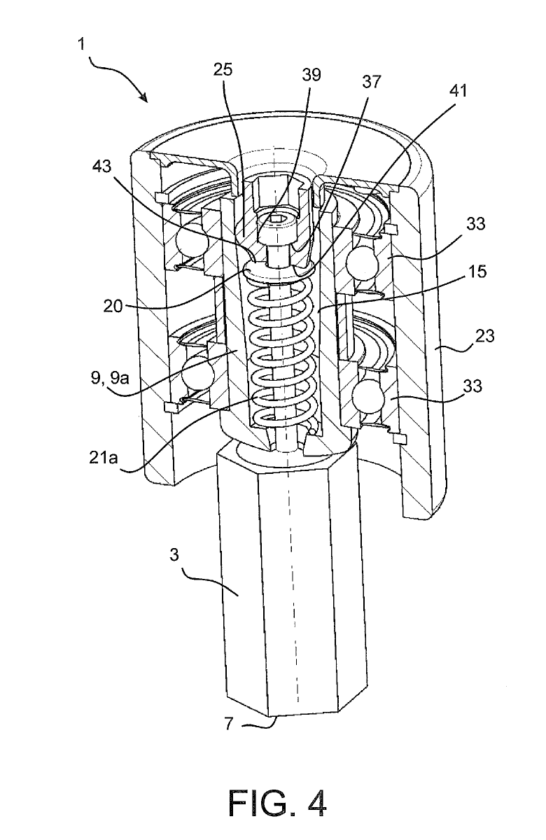

FIG. 4 shows a perspective, partially cut-away view of the roller according to FIG. 1.

In FIG. 1, the components of an inventive roller 1 are illustrated individually. The roller 1 includes a pedestal 3. The pedestal 3 can be formed in a rod- and/or pin-shaped manner. An outer wall 5 of the pedestal 3 can have, e.g., a cylindrical shape or, as illustrated, an angular cross-section and in particular a four-, six- or multi-cornered cross-section. The pedestal 3 can have a not-illustrated thread on a lower end side 7, by which the pedestal 3 can be affixed to a mount or a supporting component. To simplify the screwing-on, the pedestal 3 can be rotated at its four-, six- or many-cornered cross-section by a tool, such as e.g., an open-ended or open-jawed wrench.

In the assembled state, an axle body 9 sits on the base 3. The axle body 9 can, as illustrated, be formed as a sleeve 9a. On an end depicted below, the axle body 9 and/or the sleeve 9a includes a first spherical plain bearing part 11a of a spherical plain bearing 11. The first spherical plain bearing part 11a forms a ball-shaped head 12a of a ball-and-socket joint 12. A second spherical plain bearing part 11b and/or a ball socket 12b is associated with the first spherical plain bearing part 11a and/or the ball-shaped head 12a. The second spherical plain bearing part 11b and/or a ball socket 12b is disposed on the pedestal 3 at an upper end side 13 that is opposite of the lower end side 7.

The sleeve 9a has a sleeve bore 14. The sleeve bore 14 is not required to be produced by drilling; it can also be machined by other processes, such as e.g., boring, grinding or by shaping, in particular plastic deformation, in the sleeve 9a. The sleeve bore 14 can, as illustrated, have a tapered inner wall 15. A bore 16 is provided on a bottom 16 of the sleeve 9a; at the same time, the bottom in particular represents the ball-shaped head 12a. Thus, the bore 16 is provided to guide a screw 17 through the sleeve 9a and/or the ball-shaped head 12a and to screw into a thread pitch 18 of the pedestal 3. In addition to a screw head 17a, the screw 17 includes a shaft 17b and a threaded segment 17c, which is screwed into the thread pitch 18 of the pedestal.

Together with an eccentric component 19, a spherical washer 20, and a spring 21, the screw 17 forms a clamping device 22. In addition, the clamping device 22 also forms a fine adjustment device to order to be able to adjust the angular position of a roller tube 23 relative to the axial body 9 and/or the sleeve 9a. Therefore, the eccentric component 19 has an eccentric projection 25 that is supported on an inner wall 15 of the sleeve 9a that downwardly narrows in diameter. The screw 17 includes screw head 17a having a screw profile, in particular an inner six-edge profile or inner multi-edge profile, that is accessible from an end side 27 of the roller tube 23 that is opposite of the pedestal 3. In the same manner, the eccentric component 19 includes a screw profile, in particular an inner six-edge profile or an inner multi-edge profile, which is also accessible from the end side 27 of the roller tube 23 that is opposite of the pedestal 3. In the exemplary embodiment, a cover 29 is provided on the end side 27 of the roller tube 23. The cover 29 can, as illustrated, have an opening 31 in order to guide a tool, such e.g., a screw driver, through the cover 29, in order to be able to reach the eccentric component 19 and the screw head 17a.

In FIG. 2, the inventive roller 1 is illustrated in cross-section in an assembled state. The roller tube 23 is, in the exemplary embodiment, rotatably borne on the axle body 9 and/or the sleeve 9a by two roller bearings 33. A thread 35 is machined onto the lower end side 7 of the pedestal 3, by which the pedestal 3 can be affixed to a mount or a supporting component. On an opposite side, the pedestal 3 has a thread pitch 18. A lower side 37 of the screw head 17a abuts on an annular seat 39 of the eccentric component 19. A bottom 41 of the eccentric component 19 abuts on an upper side 43 of the spherical washer 20 and presses it against the compression spring coil 21a, which presses the sleeve 9a having its first spherical plain bearing part 11a, i.e. having the ball-shaped head 12a, against the second spherical plain bearing part 11b, i.e. against the ball socket 12b. The spring force and/or the spring characteristics can be set such that, during operation of the roller 1, the sleeve 9a is firmly pressed against the pedestal 3 such that the spherical plain bearing 11, which is formed by the first spherical plain bearing part 11a, i.e. the ball-shaped head 12a, and the second spherical plain bearing part 11b, i.e. the ball socket 12b, does not displaced, but rather remains fixed in spite of the operational forces that are occurring. To change the angular position of the sleeve 9a and/or the roller tube 23 relative to the pedestal 3, the screw 17 can be screwed in and screwed out. Due to the downwardly-narrowing inner wall 15, the sleeve 9a is forced into different angular positions in accordance with the axial height position of the projection 25 due to the interaction of the projection 25 of the eccentric component 19 with the tapered inner wall 15. The axial height position of the projection 25 is adjusted by screwing in and screwing out of the screw 17. In addition, by rotating the eccentric component 19, the particular radial direction can be set, in which the sleeve 9a should incline away in a deviating manner from the axial extension of the pedestal 3 at an angular position corresponding to the height position of the projection 25.

FIG. 3 shows the roller 1 in a top view. The projection 25 of the eccentric component 19 can be seen through the opening 31 of the cover 29. The projection 25 functions as a type of cam that rolls on the tapered inner wall 15 as a cam follower. In the position illustrated in FIG. 3, the projection 25 points leftward, i.e. the projection 25 is located in a 9 o'clock position. Therefore, the roller tube 23 is inclined leftward from the vertical direction, i.e. inclined away from the depth direction of FIG. 3. A first inner six-edge profile 45 of the eccentric component 19 and a second inner six-edge profile 47 of the screw 17, which is disposed coaxially thereto, can also be seen.

FIG. 4 shows again the design according to FIG. 2, however instead of a cross-sectional view of the roller, in a perspective, partially cut-away view.

### REFERENCE NUMBER LIST

1 Roller

3 Pedestal

5 Tube wall

7 Lower end side

9 Axle body

9a Sleeve

11 Spherical plain bearing

11a First spherical plain bearing part

11b Second spherical plain bearing part

12 Ball-and-socket joint

12a Ball-shaped head

12b Ball socket

14 Sleeve bore

15 Tapered inner wall

16 Bore

17 Screw

17a Screw head

17b Shaft

17c Threaded segment

18 Thread pitch

19 Eccentric component

20 Spherical washer

21 Spring

21a Compression spring coil

22 Clamping device

23 Roller tube

25 Eccentric projection

27 End side

29 Cover

31 Opening

33 Roller bearing

35 Thread

37 Lower side

39 Annular seat

41 Bottom

43 Upper side

45 First inner six-edge profile

47 Second inner six-edge profile

1.-11. (canceled)

12. A roller comprising:
a pedestal,
an axle body inclineably attached to the pedestal via a fixable spherical plain bearing,
at least one roller bearing supported by the axle body, and
a roller tube rotatably supported by the at least one roller bearing such that the roller tube is rotatable relative to the pedestal.

13. The roller according to claim 12, wherein the spherical plain bearing is formed as a ball-and-socket joint having:
a first spherical plain bearing part connected with or defined by the axle body and
a second spherical plain bearing part connected with or defined by the pedestal.

14. The roller according to claim 13, wherein:
the first spherical plain bearing part comprises a ball-shaped head and
the second spherical plain bearing part comprises a ball socket.

15. The roller according to claim 14, wherein the axle body comprises a sleeve having a sleeve bore, and the roller further comprises:
a clamping device at least partially disposed in the sleeve bore and configured to clamp the first spherical plain bearing part against the second spherical plain bearing part.

16. The roller according to claim 15, wherein the clamping device includes a screw having:
a screw head rotatably borne relative to the sleeve and
a threaded segment screwed into the pedestal.

17. The roller according to claim 16, wherein the clamping device further includes:
a spring disposed between the screw and the sleeve and configured to urge the first spherical plain bearing part against the second spherical plain bearing part in a friction-fit manner to fix the spherical plain bearing.

18. The roller according to claim 17, wherein the spring is a compression coil spring.

19. The roller according to claim 18, wherein:
the screw has a shaft that extends through the first spherical plain bearing part, and the threaded segment of the screw is screwed into the pedestal proximal to the second spherical plain bearing part.

20. The roller according to claim 19, further comprising:
an eccentric component that holds the screw head and has an eccentric projection, which is rotatably supported relative to an inner wall of the sleeve bore.

21. The roller according to claim 20, wherein the inner wall of the sleeve bore narrows in diameter in a direction towards the pedestal.

22. The roller according to claim 21, wherein the eccentric component is rotatably borne between the screw head and a spherical washer, the spherical washer being biased by the compression coil spring coil against the eccentric component.

23. The roller according to claim 22, wherein the screw head has an inner multi-edge profile that is accessible from an end side of the roller tube that is opposite of the pedestal.

24. The roller according to claim 23, wherein the eccentric component has an inner multi-edge screw profile that is accessible from an end side of the roller tube that is opposite of the pedestal.

25. The roller according to claim 12, wherein the axle body comprises a sleeve having a sleeve bore, and the roller further comprises:
a clamping device at least partially disposed in the sleeve bore and configured to fix the spherical plain bearing.

26. The roller according to claim 25, wherein the clamping device includes:
a screw having a screw head rotatably borne relative to a first end of the sleeve, a shaft extending through the sleeve and a threaded segment screwed into the pedestal, and
a coil spring disposed around the screw shaft between the screw head and a second end of the sleeve that is adjacent to the pedestal, the spring being configured to fix the spherical plain bearing in a friction-fit manner.

27. The roller according to claim 25, further comprising:
an eccentric component having an eccentric projection that is rotatably supported relative to an inner wall of the sleeve bore.

28. The roller according to claim 27, wherein the inner wall of the sleeve bore narrows in diameter in a direction towards the pedestal.

29. A roller comprising:
a pedestal,
an axle body attached to the pedestal,
a spherical plain bearing being disposed between the pedestal and the axle body and configured to permit a longitudinal axis of the axle body to incline relative to a longitudinal axis of the pedestal,
a clamp disposed at least partially within the axle body and being configured to fix an inclination of the axle body relative to the pedestal,
at least one roller bearing supported by the axle body, and
a roller tube rotatably supported by the at least one roller bearing such that the roller tube is rotatable relative to the pedestal.

30. The roller according to claim 29, wherein the axle body has a bore that narrows in diameter in a direction towards the pedestal, and the roller further comprises:
an eccentric component disposed in the bore and having an eccentric projection that is movable within the bore along the longitudinal axis of the axle body, the eccentric component and the sleeve bore being configured to incline the longitudinal axis of the axle body farther relative to the longitudinal axis of the pedestal when the eccentric component is moved closer to the pedestal.

31. The roller according to claim 30, wherein the spherical plain bearing is defined by adjacent surfaces of the axle body and the pedestal.
